(19) United States
(12) Patent Application Publication
(10) Pub. No.: US 2012/0007503 A1
(43) Pub. Date: Jan. 12, 2012

(54) Plasma Generating Apparatus

(75) Inventors: Hyungjoon Kim, Seoul (KR); Sang Jean Jeon, Hwaseong-si (KR); Yury Tolmachev, Suwon-si (KR); Vasily Pashkovskiy, Suwon-si (KR); Sangheon Lee, Seongnam-si (KR); Yunkwang Jeon, Seoul (KR)

(73) Assignee: SAMSUNG ELECTRONICS CO., LTD., Suwon-si (KR)

(21) Appl. No.: 13/177,016

(22) Filed: Jul. 6, 2011

(30) Foreign Application Priority Data
Jul. 6, 2010 (KR) 10-2010-0064685

(51) Int. Cl. H05H 1/24

(52) U.S. Cl. 315/34

(57) ABSTRACT

At least two antenna coils are electrically connected in parallel to each other to generate uniform high density plasma, and capacitors are installed between the respective antenna coils and a ground to minimize an antenna voltage, thereby minimizing the effect of capacitive plasma coupling due to the antenna voltage.

### CROSS-REFERENCE TO RELATED APPLICATION

This application claims priority under 35 U.S.C. §119 to Korean Patent Application No. 2010-0064685, filed on Jul. 6, 2010 in the Korean Intellectual Property Office (KIPO), the entire contents of which is incorporated herein by reference.

### BACKGROUND

1. Field

Example embodiments relate to a plasma generating apparatus to generate uniform high density plasma.

2. Description of the Related Art

Generally, plasma is ionized gas including ions, electrons, radicals, and the like. Plasma is regarded as a fourth state of matter due to the considerably different electrical and thermal properties thereof as compared to common gases. If an electric field or a magnetic field is applied to plasma, the plasma particles are accelerated or diffused within the plasma or into a solid surface coming into contact with the plasma, causing chemical and physical reactions with the solid surface. Accordingly, plasma has been used in a variety of surface treatment processes, such as, e.g., etching and deposition, included in a semiconductor manufacturing process to form a fine pattern on a semiconductor wafer or a glass substrate of a liquid crystal display device.

As the integration degree of a semiconductor device increases, the line width of a fine pattern continues to be reduced. Thus, to improve the uniformity of plasma used to form the fine pattern, there is a demand for a plasma generating apparatus to generate high density plasma. Examples of high density plasma generating apparatuses include an Inductively Coupled Plasma (ICP) generating apparatus and a Capacitively Coupled Plasma (CCP) generating apparatus. The ICP generating apparatus has been more widely used than the CCP generating apparatus because the ICP generating apparatus may provide electromagnetic energy for generation of plasma with less loss of plasma while assuring that a sample, e.g., a semiconductor wafer or a glass substrate, is not affected by an electromagnetic field.

In the ICP generating apparatus, a Radio-Frequency (RF) source applies RF power to an antenna installed above a plasma generating chamber to create an inductive electric field in the chamber. As the inductive electric field ionizes gas introduced into the chamber, plasma is generated. The generated plasma is used for etching of and deposition on a semiconductor wafer, glass substrate, or the like mounted on a chuck within the chamber.

However, because the antenna of the ICP generating apparatus uses inductive coils connected in series and has a large voltage drop, the effect of capacitive plasma coupling may be increased. This may reduce power efficiency and maintaining uniformity of plasma is difficult. In particular, when processing a sample having a wide area, uniformly distributing plasma due to low density of plasma may be difficult.

### SUMMARY

Therefore, example embodiments provide a plasma generating apparatus with an improved antenna configuration to realize uniform distribution of high density plasma having high inductive coupling efficiency.

Additional example embodiments will be set forth in part in the description which follows and, in part, will be obvious from the description, or may be learned by practice of the invention.

In accordance with at least one example embodiment, the plasma generating apparatus includes a radio-frequency generator to supply radio-frequency power, an antenna system including a plurality of antenna coils to generate an inductive electric field upon receiving the radio-frequency power, and a reaction chamber in which plasma is generated as reaction gas is ionized by the inductive electric field, wherein the plurality of antenna coils are wound at an interval to cross each other so as to be electrically connected in parallel to each other.

The plurality of antenna coils may be wound on a bobbin to cross each other.

The plurality of antenna coils may be respectively provided with capacitors, and the capacitors may be inserted between the respective antenna coils and a ground.

A balance ring may be provided at connecting portions of the antenna coils and the capacitors.

The balance ring may be made of an electrically conductive metal.

In accordance with another example embodiment, a plasma generating apparatus includes a reaction chamber in which plasma is generated, a radio-frequency generator to supply radio-frequency power for plasma generation, and a plurality of antenna coils to generate an inductive electric field upon receiving the radio-frequency power, wherein the plurality of antenna coils are wound at an interval to cross each other so as to be electrically connected in parallel to each other.

### BRIEF DESCRIPTION OF THE DRAWINGS

Example embodiments will be more clearly understood from the following brief description taken in conjunction with the accompanying drawings. FIGS. 1-8 represent non-limiting, example embodiments as described herein.

These and/or other aspects of the invention will become apparent and more readily appreciated from the following description of the embodiments, taken in conjunction with the accompanying drawings of which:

FIG. 1 is a diagram of a plasma generating apparatus in accordance with at least one example embodiment;

FIG. 2 is a perspective view illustrating an antenna system of the plasma generating apparatus in accordance with at least one example embodiment;

FIG. 3 is a plan view of the antenna system illustrated in FIG. 2;

FIG. 4 is an equivalent circuit diagram of the antenna system illustrated in FIG. 2;

FIG. 5 is a perspective view illustrating an antenna system of the plasma generating apparatus in accordance with at least one example embodiment;

FIG. 6 is a plan view of the antenna system illustrated in FIG. 5;

FIG. 7 is an equivalent circuit diagram of the antenna system illustrated in FIG. 5; and

FIG. 8 is a graph illustrating voltage applied to antenna coils of the plasma generating apparatus.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Reference will now be made in detail to the example embodiments, examples of which are illustrated in the accompanying drawings, wherein like reference numerals refer to like elements throughout.

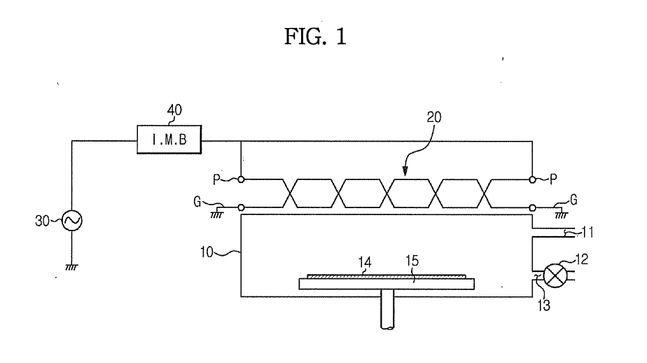

FIG. 1 is a diagram of a plasma generating apparatus in accordance with at least one example embodiment.

As illustrated in FIG. 1, the plasma generating apparatus may include a reaction chamber 10 (e.g., a vacuum chamber, in which plasma generated via gas ionization is received) and an antenna system 20 provided above the reaction chamber 10 for applying Radio-Frequency (RF) power.

The reaction chamber 10 may provide a processing region in which a semiconductor manufacturing process using plasma is performed. The reaction chamber 10 may maintain the processing region at a constant vacuum degree and constant temperature. The reaction chamber 10 may have a gas injection port 11 through which reaction gas may be injected from an external source. The reaction chamber 10 may have a vacuum pump 12 and a gas discharge port 13 to maintain the interior of the reaction chamber 10 at a constant vacuum degree and discharge the reaction gas after completion of a reaction. The reaction chamber 10 may also include an electrostatic chuck 15, on which a sample 14, e.g., a semiconductor wafer, a glass substrate, or the like, may be placed.

Although not illustrated in FIG. 1, a dielectric window may be provided between the reaction chamber 10 and the antenna system 20. The dielectric window may prevent capacitive coupling between the antenna system 20 and plasma (generated in the reaction chamber 10), thereby allowing transmission of RF power energy via only inductive coupling. The window may be made of a dielectric substance, e.g., alumina or quartz.

The plasma generating apparatus according to at least one example embodiment may further include a radio-frequency generator 30 to generate RF power to be fed to the antenna system 20, and an impedance matching box 40 to transmit the RF power from the radio-frequency generator 30 to the antenna system 20 with minimal loss.

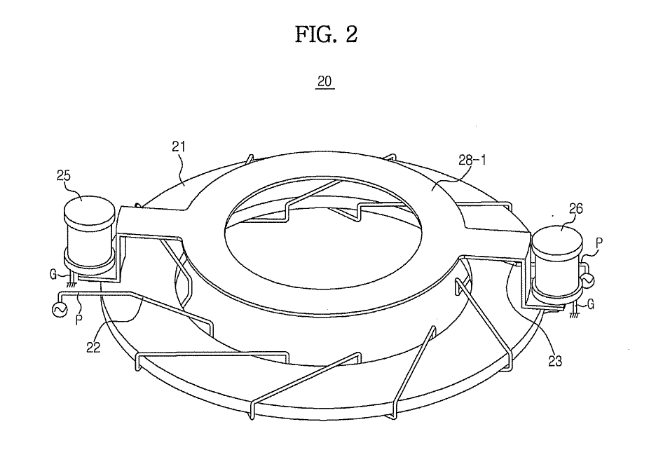

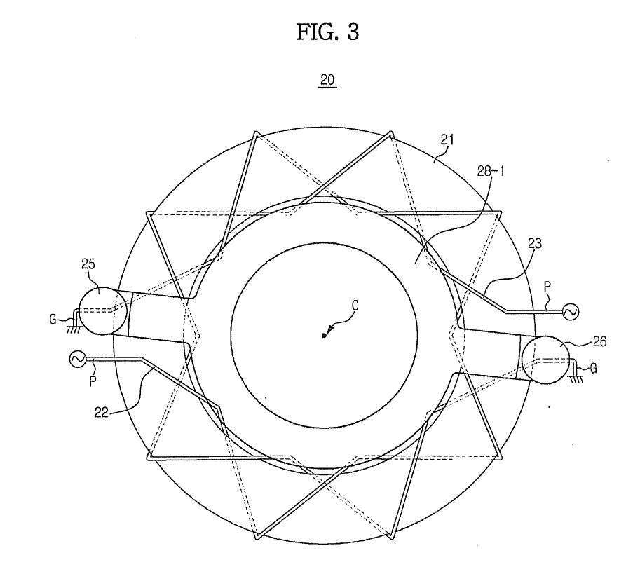

FIG. 2 is a perspective view illustrating the antenna system of the plasma generating apparatus according to at least one example embodiment, and FIG. 3 is a plan view of the antenna system illustrated in FIG. 2.

As shown in FIGS. 2 and 3, the antenna system 20 may include a flat doughnut shaped bobbin 21 having a set thickness, and at least two antenna coils 22 and 23 wound on the flat doughnut shaped bobbin 21.

The two antenna coils 22 and 23 of the antenna system 20 may be wound at a constant interval to cross each other, so as to be electrically connected in parallel to each other, in order to generate uniform high density plasma.

The two electrically parallel antenna coils 22 and 23 of the antenna system 20 each may have a power end P and a ground end G such that the power end P and ground end G of each antenna coil 22 or 23 may be symmetrically positioned on the basis of the center C of an imaginary circle. The antenna coils 22 and 23 may be twisted together to define double helical windings having a constant interval.

The power ends P of the respective antenna coils 22 and 23 may be remotely located perpendicular to the reaction chamber 10, and the ground ends G of the respective antenna coils 22 and 23 may be closely located perpendicular to the reaction chamber 10.

As described above, the antenna coils 22 and 23 of the antenna system 20 may be wound at a fixed interval to define double helical windings crossing each other. The double helical windings may have the same radius and may be connected in parallel to each other. Also, as the power ends P of the respective antenna coils 22 and 23 are located remote from the reaction chamber 10, e.g., at upper positions and the ground ends G are located close to the reaction chamber 10, e.g. at lower positions than the power ends P, high voltage may be applied to the power ends P, and consequently, plasma density drop due to ion loss may be reduced and/or minimized.

The antenna system 20 according to example embodiments may further include two capacitors 25 and 26 provided respectively at the two antenna coils 22 and 23. The two capacitors 25 and 26 provided respectively at the two antenna coils 22 and 23 may minimize voltage applied to the antenna coils 22 and 23.

In the antenna system 20 a balance ring 28-1 may be provided at connecting portions of the two antenna coils 22 and 23 and the two capacitors 25 and 26. The balance ring 28-1 may be made of an electrically conductive metal and electrically short-circuits the connecting portions of the two antenna coils 22 and 23 and the two capacitors 25 and 26, thereby equalizing voltage applied to the respective antenna coils 22 and 23.

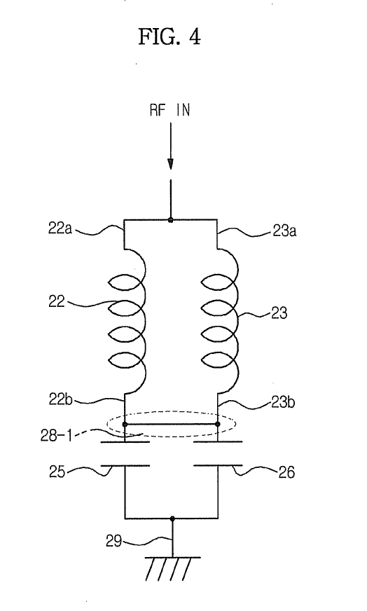

FIG. 4 is an equivalent circuit diagram of the antenna system illustrated in FIG. 2.

As shown in FIG. 4, the antenna system 20 may have a parallel circuit in which the two antenna coils 22 and 23 may be electrically connected in parallel to each other.

Upper ends 22a and 23a of the antenna coils 22 and 23 may be connected to an input terminal RF IN of RF power fed from the radio-frequency generator 30, and lower ends 22b and 23b of the antenna coils 22 and 23 may be connected to a ground terminal 29.

The capacitors 25 and 26 may be located between the antenna coils 22 and 23 and the ground terminal 29. The two capacitors 25 and 26 between the antenna coils 22 and 23 and the ground terminal 29 may reduce a voltage applied to the ends of the antenna coils 22 and 23 toward the ground terminal 29 while maintaining the same voltage difference between both ends of each antenna coil 22 or 23, e.g., between the upper end 22a or 23a and the lower end 22b or 23b of each antenna coil 22 or 23.

In addition, the balance ring 28-1 may be inserted between the connecting portions of the antenna coils 22 and 23 and the capacitors 25 and 26 and may equalize voltage applied to the antenna coils 22 and 23 despite a capacitance error of the capacitors 25 and 26 provided at the antenna coils 22 and 23.

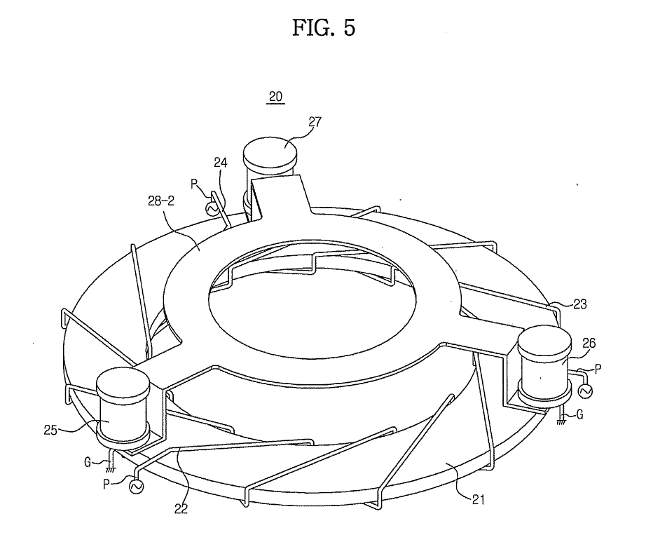

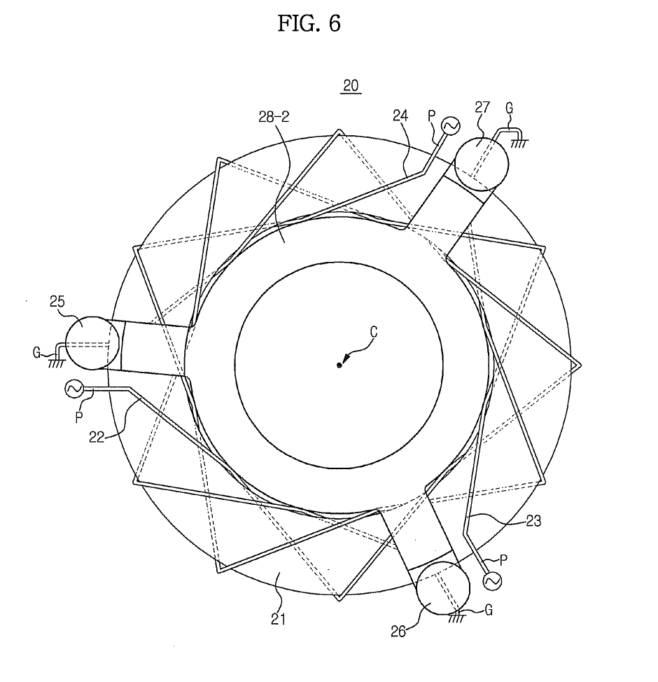

FIG. 5 is a perspective view illustrating an antenna system of the plasma generating apparatus in accordance with another example embodiment. FIG. 6 is a plan view of the antenna system illustrated in FIG. 5. The same elements as those of FIGS. 2 and 3 are designated by the same reference numerals and the same terms to minimize repetitive description thereof.

In FIGS. 5 and 6, the antenna system 20 may include the flat doughnut shaped bobbin 21 and two or more (e.g., three) antenna coils 22, 23 and 24 wound on the flat doughnut shaped bobbin 21.

The three antenna coils 22, 23 and 24 of the antenna system 20 may be wound at an interval to cross one another, so as to be electrically connected in parallel to one another, in order to generate uniform high density plasma.

The three antenna coils 22, 23 and 24 of the antenna system 20 each may have a power end P and a ground end G such that the power end P and ground end G of each antenna coil 22, 23 or 24 may be symmetrically positioned on the basis of the center C of an imaginary circle. The antenna coils 22, 23 and 24 may be twisted together to define triple helical windings having a set interval.

The power ends P of the respective antenna coils 22, 23 and 24 may be remotely located perpendicular to the reaction chamber 10, and the ground ends G of the respective antenna coils 22, 23 and 24 may be closely located perpendicular to the reaction chamber 10.

As described above, the antenna coils 22, 23 and 24 of the antenna system 20 may be wound at an interval to define triple helical windings crossing one another. The triple helical windings may have the same radius and may be connected in parallel to one another. Also, as the power ends P of the respective antenna coils 22, 23 and 24 may be located remote from the reaction chamber 10, e.g., at upper positions and the ground ends G may be located close to the reaction chamber 10, e.g., at lower positions than the power ends P, high voltage may be applied to the power ends P and consequently, plasma density drop due to ion loss may be reduced and/or minimized.

The antenna system 20 in accordance with the example embodiment may further include three capacitors 25, 26 and 27 provided respectively at the three antenna coils 22, 23 and 24. The three capacitors 25, 26 and 27 provided respectively at the three antenna coils 22, 23 and 24 may minimize voltage applied to the antenna coils 22, 23 and 24.

In the antenna system 20 in accordance with the example embodiment, a balance ring 28-2 may be provided at connecting portions of the three antenna coils 22, 23 and 24 and the three capacitors 25, 26 and 27. The balance ring 28-2 may be made of an electrically conductive metal and electrically short-circuits the connecting portions of the three antenna coils 22, 23 and 24 and the three capacitors 25, 26 and 27, thereby equalizing voltage applied to the respective antenna coils 22, 23 and 24.

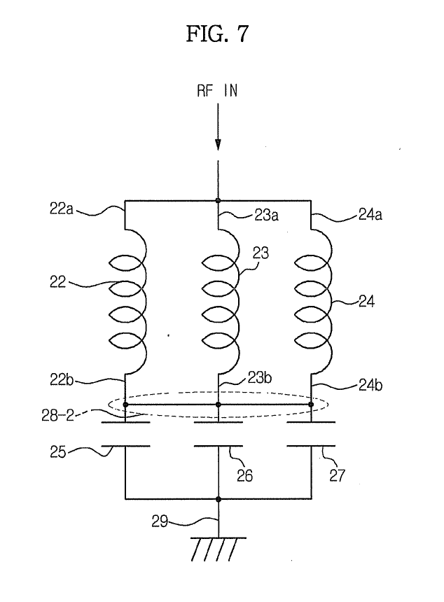

FIG. 7 is an equivalent circuit diagram of the antenna system illustrated in FIG. 5.

As shown in FIG. 7, the antenna system 20 may have a parallel circuit in which the three antenna coils 22, 23 and 24 are electrically connected in parallel to one another.

Upper ends 22a, 23a and 24a of the antenna coils 22, 23 and 24 may be connected to the input terminal RF IN of RF power fed from the radio-frequency generator 30, and lower ends 22b, 23b and 24b of the antenna coils 22, 23 and 24 may be connected to the ground terminal 29.

The capacitors 25, 26 and 27 may be located between the antenna coils 22, 23 and 24 and the ground terminal 29. The three capacitors 25, 26 and 27 between the antenna coils 22, 23 and 24 and the ground terminal 29 may minimize and/or reduce voltage applied to the ends of the antenna coils 22, 23 and 24 toward the ground terminal 29 while maintaining the same voltage difference between both ends of each antenna coil 22, 23 or 24, e.g., between the upper end 22a, 23a or 24a and the lower end 22b, 23b or 24b of each antenna coil 22, 23 or 24.

In addition, the balance ring 28-2 may be inserted between the connecting portions of the antenna coils 22, 23 and 24 and the capacitors 25, 26 and 27 and serves to equalize voltage applied to the antenna coils 22, 23 and 24 despite a capacitance error of the capacitors 25, 26 and 27 provided at the antenna coils 22, 23 and 24.

Hereinafter, the operation and effects of the antenna system having the above described configuration, included in the plasma generating apparatus to generate uniform high density plasma, will be described.

Referring to FIG. 1, after the interior of the reaction chamber 10 is initially exhausted to a vacuum pressure by the vacuum pump, reaction gas for plasma generation may be injected into the reaction chamber 10 through the gas injection port 11 and may be maintained at a desired pressure.

If RF power fed from the radio-frequency generator 30 is applied to the antenna system 20, a time-varying magnetic field may be created in a direction perpendicular to a plane of the antenna system 20, such that an inductive electric field may be created within the reaction chamber 10. The inductive electric field may accelerate reaction gas particles within the reaction chamber 10, causing generation of ions and radicals via collision of the accelerated particles. The resulting plasma may be composed of the ions and radicals and may be used for etching of or deposition on the sample 14 placed on the electrostatic chuck 15 within the reaction chamber 10.

The configuration of the antenna system 20 of the plasma generating apparatus to realize uniform distribution of high density plasma having high inductive coupling efficiency will be described below.

The antenna system 20 in accordance with at least one of the example embodiments described above, and as illustrated in FIGS. 2 and 3, may include the two antenna coils 22 and 23 wound at an interval on the flat doughnut shaped bobbin 21 having a set thickness. The two antenna coils 22 and 23 may define double helical windings, which have the same radius and cross each other so as to be connected in parallel to each other.

Voltage from the RF power input terminal of the antenna coils 22 and 23, e.g., from the radio-frequency generator 30 may increase because current increases at a radio frequency.

In the antenna system, inserting the capacitors 25 and 26 between the two antenna coils 22 and 23 and the ground terminal 29 as illustrated in FIG. 4, may reduce voltage applied to the ends of the antenna coils 22 and 23 toward the ground terminal 29 while maintaining the same voltage difference between both ends of each antenna coil 22 or 23, e.g., between the upper end 22a or 23a and the lower end 22b or 23b of each antenna coil 22 or 23. This may reduce and/or minimize an electrostatic field created by antenna voltage to reduce and/or minimize the effect of capacitive coupling due to the antenna voltage, thereby restricting sputtering at the inner wall of the reaction chamber 10 and improving uniformity of plasma.

However, if the capacitors 25 and 26 are inserted between the two antenna coils 22 and 23 and the ground terminal 29, e.g., are connected to the ground terminal 29 of the antenna coils 22 and 23, a current difference between the two antenna coils 22 and 23 may occur due to a normal capacitance error (e.g., approximately 5˜10%).

Accordingly, in the antenna system 20 of the example embodiments, the metallic balance ring 28-1 may be provided at the connecting portions of the two antenna coils 22 and 23 and the two capacitors 25 and 26 to equalize voltage applied to the antenna coils 22 and 23 and consequently, equalize current applied to both the ends of the respective antenna coils 22 and 23, enabling generation of uniform high density plasma.

In addition, the antenna system 20 in accordance with at least one example embodiment described above, and as illustrated in FIGS. 5 and 6, may include the three antenna coils 22, 23 and 24 wound at an interval on the flat doughnut shaped bobbin 21. The three antenna coils 22, 23 and 24 may define triple helical windings, which may have the same radius and cross one another so as to be connected in parallel to one another.

Voltage from the RF power input terminal of the antenna coils 22, 23 and 24, e.g., from the radio-frequency generator 30 may increase because current increases at a radio frequency.

In the antenna system 20 of the example embodiment, as a result of inserting the capacitors 25, 26 and 27 between the three antenna coils 22, 23 and 24 and the ground terminal 29 as illustrated in FIG. 7, minimizing and/or reducing voltage applied to the ends of the antenna coils 22, 23 and 24 toward the ground terminal 29 while maintaining the same voltage difference between both ends of each antenna coil 22, 23 or 24, e.g., between the upper end 22a, 23a or 24a and the lower end 22b, 23b or 24b of each antenna coil 22, 23 or 24 may be possible. This may reduce and/or minimize an electrostatic field created by antenna voltage to reduce and/or minimize the effect of capacitive coupling due to the antenna voltages, thereby restricting sputtering at the inner wall of the reaction chamber 10 and improving uniformity of plasma.

However, if the capacitors 25, 26 and 27 are inserted between the three antenna coils 22, 23 and 24 and the ground terminal 29, e.g., are connected to the ground terminal 29 of the antenna coils 22, 23 and 24, a current difference between the three antenna coils 22, 23 and 24 may occur due to a normal capacitance error (e.g., approximately 5˜10%).

Accordingly, in the antenna system 20 of at least one example embodiment, the metallic balance ring 28-2 may be provided at the connecting portions of the three antenna coils 22, 23 and 24 and the three capacitors 25, 26 and 27 to equalize voltage applied to the antenna coils 22, 23 and 24 and consequently, equalize current applied to both the ends of the respective antenna coils 22, 23 and 24, which may enable generation of uniform high density plasma.

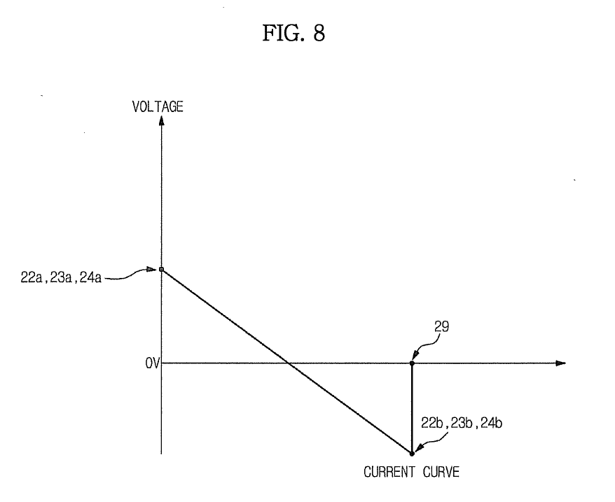

FIG. 8 is a graph illustrating voltage applied to the antenna coils of the plasma generating apparatus.

As will be appreciated from FIG. 8, a voltage applied to the upper end 22a, 23a or 24a of each antenna coil 22, 23 or 24 may have the same absolute value as that applied to the lower end 22b, 23b or 24a of the antenna coil 22, 23 or 24 on the basis of the ground terminal 29. Thus, halving the magnitude of voltage applied to the power end P and the ground end G of each antenna coil 22, 23 or 24 may be possible, thereby reducing and/or minimizing sputtering at the bottom of the reaction chamber 10.

The example embodiments describe at least two (two or three) antenna coils, which cross one another at an interval so as to be connected in parallel to one another, by way of example, but are not limited thereto, and other antenna systems having various configurations may accomplish the same effects using the capacitors and balancer ring described above.

As is apparent from the above description, according to an antenna system of a plasma generating apparatus described in the example embodiments, at least two antenna coils may be electrically connected in parallel to each other to generate uniform high density plasma, and capacitors may be installed between the respective antenna coils and a ground to reduce and/or minimize an antenna voltage, thereby reducing and/or minimizing the effect of capacitive plasma coupling due to the antenna voltage. This may restrict sputtering at the inner wall of a reaction chamber, resulting in improved uniformity of plasma.

Further, owing to a metallic balance ring provided at connecting portions of the respective antenna coils and the capacitors, reducing and/or minimizing a current difference between the respective antenna coils despite a capacitance error (e.g., approximately 5˜10%) of the respective capacitors installed to the antenna coils may be possible, resulting in generation of uniform high density plasma.

Although example embodiments have been shown and described, it would be appreciated by those skilled in the art that changes and/or variations in form and detail may be made in these embodiments without departing from the scope and spirit of the claims, the scope of which is defined in the claims and their equivalents.

What is claimed is:

1. A plasma generating apparatus comprising:
a radio-frequency generator configured to supply radio-frequency power;
an antenna system including a plurality of antenna coils configured to generate an inductive electric field based on the radio-frequency power; and
a reaction chamber in which plasma is generated as reaction gas is ionized by the inductive electric field,
wherein the plurality antenna coils are wound at an interval to cross each other so as to be electrically connected in parallel to each other.

2. The apparatus according to claim 1, wherein the plurality of antenna coils are wound on a bobbin to cross each other.

3. The apparatus according to claim 1, wherein the plurality of antenna coils are respectively provided with capacitors.

4. The apparatus according to claim 3, wherein the capacitors are inserted between the respective antenna coils and a ground.

5. The apparatus according to claim 3, further comprising:
a balance ring at connecting portions of the antenna coils and the capacitors.

6. The apparatus according to claim 5, wherein the balance ring is made of an electrically conductive metal.
